(19) United States
(12) Patent Application Publication
(10) Pub. No.: US 2007/0144821 A1
(43) Pub. Date: Jun. 28, 2007

(54) Power steering system with electric motor and a vehicle which is equipped with it

(76) Inventor: Johann Merz, Schwaebisch Gmuend (DE)

Correspondence Address: KENYON & KENYON LLP, ONE BROADWAY, NEW YORK, NY, 10004, US

(21) Appl. No.: 10/571,954

(22) PCT Filed: Aug. 28, 2004
(86) PCT No.: PCT/EP04/09627

§ 371 Date: Mar. 13, 2006

(30) Foreign Application Priority Data
Sep. 11, 2003 (DE) 103 41 936.2

(51) Int. Cl. B62D 5/04

(52) U.S. Cl. 180/444

(57) ABSTRACT

Power steering systems in which an electric motor which is fed by the on-board power system applies the assisting steering force are being used to an increasing degree in vehicles. However, the on-board power system is very heavily loaded by the growing number of electric drives and loads, for example, actuating motors, heating elements and air conditioning systems, which are integrated in the vehicles. Solutions with a relatively high on-board power system voltage of, for example, 42 volts may require extensive resetting of all the relevant electric components to this higher voltage. In order to be able to make available an electrical energy supply for the electric motor independently of the on-board power system, in a power steering system, the electric motor is controlled by an electronic control unit in order to act on the toothed rack of the steering system in a manner which supplies power assistance force. In this context, the electronic control unit is fed by a first voltage which also supplies the on-board power system of the vehicle. The electric motor itself is, however, supplied by a second, e.g., higher, voltage which is generated by a generator which is not connected to the on-board power system. This generator may feed not only the electric motor of the power steering system but also possibly other electromotive drives, such as, for example, an active anti-roll bar which is arranged in the chassis. This may ensure that the electric motor which drives the steering system and possible other drive motors are fed by the generator which operates independently of the on-board system and whose output power may be adapted in an optimum manner by an electronic controller to the power which is required electric motors.

### FIELD OF THE INVENTION

The present invention relates to a power steering system with an electric motor which supplies power assistance force and to a vehicle which is equipped with it.

### BACKGROUND INFORMATION

A large proportion of conventional power steering systems operate, as in the past, with hydraulic servo motors. However, power steering systems in which an electric motor applies the assisting steering force are being increasingly used in vehicles, even in relatively large vehicles. Such steering systems are also referred to as electric steering systems. The electric motor is usually fed by the on-board power system voltage of the vehicle which is currently still 12 volts in passenger cars, which corresponds to a generator voltage of approximately 14 volts. As a result of the increasing number of electric drives and loads such as, for example, actuating motors, heating elements and air conditioning systems, which are integrated in vehicles, the on-board power system voltage is subject to greater and greater loading. The problem is aggravated since the power demand from individual components is becoming larger. For example, a maximum current level of approximately 80 A would have to be made available for the electric steering system of a medium range passenger car, while a brief increase in power (power gradient) of 600 kA/sec and more may occur when there are large dynamic loads. For this reason, serious consideration is being given to equipping vehicles with a more powerful on-board power system which has, for example, a generator voltage of 42 volts. However, this intention requires extensive resetting of all the relevant electric components to the higher voltage.

As an alternative to this, consideration is being given to a second on-board power system which is to be installed in addition to the existing on-board power system. In such a context the question arises as to whether two on-board power systems of equal power, for example, two times 14 volts, should be operated in parallel. This would provide a uniform voltage value so that it would not be necessary to reset the voltage. However, the 14 volts would continue to be too low to be able to cover relatively high power levels. On the other hand, if a hybrid concept with two different voltages, for example, with 14 volts and 42 volts, were to be selected, a considerable degree of expenditure for implementing this would be necessary. There are also specific proposals which tend in this direction for steering systems:

German Published Patent Application No. 38 33 306 describes a servo-assisted steering system which has an electric motor which is fed by a higher voltage (48 volts) than the on-board power system voltage (12 volts). Both voltages are generated by a generator which correspondingly has two sets of armature windings. As a result, this design of the generator is costly to implement. Furthermore, it is particularly difficult to configure the generator such that it simultaneously satisfies the requirements of the on-board power system and those of the electric motor. However, as a result the power supply of the electric motor is not completely independent of the on-board power system.

### SUMMARY

Example embodiments of the present invention may provide a steering system in which the supply of electrical energy to the electric motor may be set and changed independently of the on-board power system. Furthermore, a vehicle which is equipped with such a steering system is described herein.

Accordingly, a power steering system may be provided in which an electric motor is controlled by an electronic control unit and acts on the toothed rack of the steering system in a manner which supplies the power assistance force, with the steering system being defined in that the electronic control unit is fed by a first voltage which also supplies the on-board power system of the vehicle, and in that the electric motor itself is supplied by a second voltage which is generated by a generator which is not connected to the on-board power system. This generator feeds the electric motor of the power steering system and may possibly also supply power to other electromotive drives which are arranged outside the power steering system. Such a drive may be, for example, an active anti-roll bar which is arranged in the chassis and which the generator also feeds by the second voltage generated by it.

It may therefore be ensured that the electric motor which drives the steering system, and possible other drive motors, are fed by a generator which operates independently of the on-board power system and whose output power is adapted by an electronic controller, e.g., in an optimum manner to the power required electric motors. In other words: the generator power which is generated is set and adapted dynamically, e.g., in an optimum manner to the requirements of the electric motors and auxiliary drives, e.g., the electric assisting power steering system.

This maybe performed, for example, by a control gear which is controlled by the electric control unit and that sets the feed power for the electric motor. However it is also possible to use an externally excited generator whose excitation, and thus whose output power, is influenced directly by the electric control unit so that precisely the power required instantaneously by the electric motor is generated.

Example embodiments of the present invention are described in more detail below with reference to the appended Figures.

### BRIEF DESCRIPTION OF THE DRAWINGS

FIG. 1 schematically illustrates a power steering system according to an example embodiment of the present invention in which the electric control unit controls the control gear of the electric motor.

FIG. 2 schematically illustrates, in a partial section, an example embodiment with an externally excited generator, in which the electric control unit influences the control gear and also the generator.

FIG. 3 schematically illustrates, in a partial section, an example embodiment without the control gear, in which the electric control unit influences the externally excited generator.

### DETAILED DESCRIPTION

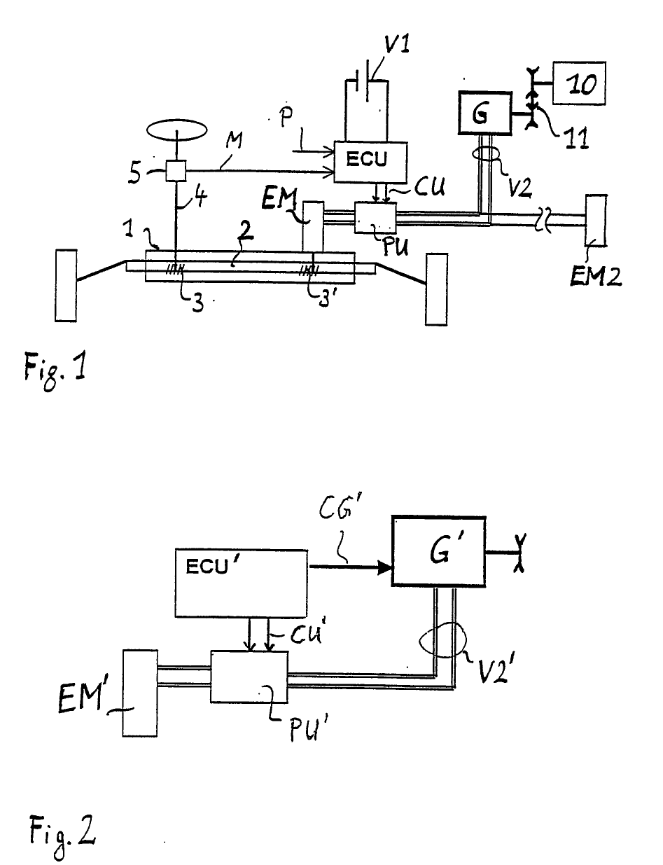

FIG. 1 schematically illustrates, as a first example, the design of a power steering system for a vehicle, in which a toothed rack 2 which is arranged in an axially displaceable fashion is arranged in a steering casing 1. A pinion 3 engages in this toothed rack 2 in an intermeshing fashion and is operatively connected to a steering spindle 4 via which the steering force which is applied by the driver is transmitted. In order to assist this manually applied force, an electric motor EM is provided which is controlled by an electronic control unit ECU and acts on the toothed rack 2 in a manner which supplies power assistance force. For this purpose, the manually applied torque M is sensed by a torque sensor 5, which is attached to torsion bar which is integrated into the steering column, and the torque M is transmitted as an input value to an electric control unit ECU. The control unit compares the input value with comparison values which are stored in the form of a characteristic curve, characteristic curve diagram, etc. Control signals for the electric steering system are calculated therefrom so that the electric motor EM generates a best possible power assistance force.

In the example illustrated in FIG. 1, a power stage which is connected upstream of the electric motor EM and which is also referred to as a control gear PU is actuated by the control unit ECU. This is done by control signals CU which the control unit ECU transmits to the control gear PU. The control gear PU includes controllable power semiconductors which converts the voltage V2, which is generated by a separate generator G and is, for example, 24 volts, e.g., into an optimum supply voltage for the electric motor EM. The separately arranged generator G is not coupled to the on-board power system whose voltage VI is usually 12 volts but instead the generator G generates a significantly higher voltage V2 which may sufficiently cover the power demand of the electric motor EM without the on-board power system being subjected to influences or interference. In this example, a 24 volt claw pole generator, e.g., a standard component from utility vehicles is used as generator G. As a result, it is possible to reduce costs. The generator G is driven by the internal combustion engine 10 of the vehicle via a V belt drive 11. The control device ECU itself operates with the on-board power system voltage so that cost-effective standard hardware may also be used for it.

FIG. 2 illustrates an example embodiment in which an externally excited generator G′ whose excitation is set by the control unit ECU′ and is changed in accordance with the requirements is used. This is done by a control voltage CG′ which the control unit ECU generates and feeds into the rotor circuit of the generator G′ in order to set the desired excitation. In this example, it is possible to generate an extremely high generator voltage V2′ of 100 volts or more. The control gear PU′ which is also actuated by the control unit ECU converts therefrom a feed voltage which may be optimum for the electric motor EM′. Since the generator G′ generates an extremely high voltage V2′, a large power potential for supplying the electric motor EM′ is available, e.g., for the dynamic control of the electric motor EM′. The control device ECU controls both the field excitation in the generator G′ (by the control voltage CG′) and the control gear PU′ (by the control signals CU′) and thus makes a very flexible control intervention into the entire system. Power levels of 3.5 kW and more may be acquired from the controlled generator G′ so that a very large amount of power steering assistance may be made available by the electric motor. The same applies to the power peaks over time, which are required in highly dynamic driving situations.

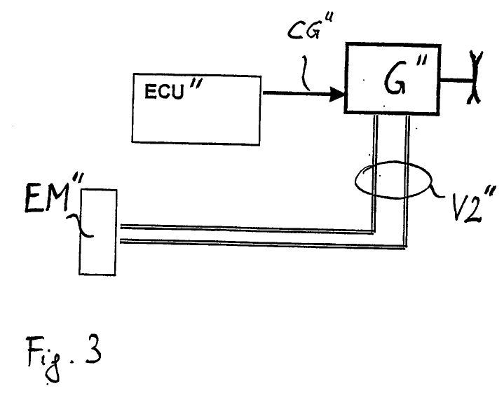

FIG. 3 illustrates an embodiment in which the externally excited generator G″ is connected directly, i.e., without a control gear, to the electric motor EM″ and supplies the required electrical power to it. For this purpose, a control voltage CG″ is generated by the control unit ECU and fed into the rotor circuit of the generator G″ so that the desired field excitation occurs in order to supply the correspondingly high generator voltage V2″ to the electric motor EM″. This configuration therefore constitutes a set of machines which are adapted to one another and are controlled centrally from the control unit ECU, the set including the externally excited generator G″ and the electric motor EM″ which is connected directly thereto.

The arrangements described herein may be extended by the voltage which is generated by the generator, and which is independent of the on-board power system, being used both for the electric motor of the power steering system and for other electric motors or electromotive drive arranged outside the power steering system, e.g., for an active anti-roll bar which is arranged in the chassis. The common power supply of the steering motor and anti-roll bar may be advantageous because these two loads may complement one another ideally in terms of power demand: this is because the power demand for the steering system is very high, e.g., when traveling slowly and when the vehicle is stationary, for example, when parking. In contrast, the power demand for stabilizing the vehicle, e.g., for stabilizing it in the transverse position, is greatest when the vehicle is traveling very fast. For this reason, such a combination is defined by a balanced power demand, which may be advantageous for the use of the generator.

The power steering system may also be provided with a circuit which carries out the following additional function:

In the case of only a low power demand, i.e., if only a small amount of power steering assistance is required, the electric motor is operated at the on-board power system voltage. This is the case, for example, when traveling straight ahead. The electric motor is disconnected from the on-board power system and connected to the generator which supplies the second higher voltage only if there is a relatively high power demand, as occurs to a particular degree when parking. For this purpose, a circuit is provided which monitors the power demand of the electric motor and correspondingly switches over between the voltages.

This means for the examples illustrated in FIGS. 1 and 2 that the electronic control unit ECU is expanded so that it monitors the first voltage VI and compares it with a predefinable minimum value. The control unit ECU controls a switching device, for example, the control gear PU, such that the first voltage V1 feeds the electric motor EM as long as this voltage U1 is above the predefinable minimum value, and that the second voltage V2 feeds the electric motor EM as soon as the first voltage V1 drops below the predefinable minimum value.

An alternative solution is that the electronic control unit monitors the supply current passing through the electric motor and compares it with a predefinable maximum value. The control unit controls the control gear such that the first voltage V1 feeds the electric motor EM as long as the supply current is below the predefinable maximum value, and that the second voltage V2 feeds the electric motor EM as soon as the supply current exceeds the predefinable maximum value.

1-10. (canceled)

11. A power steering system for a vehicle, comprising:
a steering spindle;
a steering casing;
a pinion operatively connected to the steering spindle;
a toothed rack axially displaceable in the steering casing, the pinion engaging the rack in an intermeshing fashion;
an electronic control unit; and
an electric motor controlled by the electronic control unit and arranged to act on the rack to supply a power assistance force, the power assistance force applied by the electric motor following, in accordance with a characteristic curve stored in the electronic control unit, a torque that occurs at the steering spindle, the electronic control unit supplied with a first voltage that also supplies an on-board power system of the vehicle, the electric motor supplied with a second voltage generated by a generator that is not connected to the on-board power system, the electric motor arranged as an AC motor connected to a control gear that is controlled by the control unit, the second voltage arranged as an alternating voltage that feeds the electric motor via the control gear.

12. The power steering system according to claim 11, wherein the generator is arranged an externally excited generator connected to the electronic control unit, the control unit adapted to control external excitation of the generator in order to vary the second voltage, the control unit adapted to control the control gear in order to feed the generated second voltage into the electric motor.

13. The power steering system according to claim 12, wherein the generator is arranged an externally excited multiphase current generator, the electric motor is arranged as a multiphase current motor, the control gear including a matrix converter adapted to convert phase voltages generated by the multiphase current generator into phase voltages to be fed into the multiphase current motor.

14. The power steering system according to claim 11, wherein the electronic control unit is adapted to monitor the first voltage and to compare the first voltage with a predefinable minimum value, the control unit adapted to control a switching device to feed the first voltage to the electric motor as long as the first voltage is above the predefinable minimum value and to feed the second voltage to the electric motor as soon as the first voltage drops below the predefinable minimum value.

15. The power steering system according to claim 14, wherein the switching device includes the control gear.

16. A motor vehicle, comprising:
power steering system including:
a steering spindle;
a steering casing;
a pinion operatively connected to the steering spindle;
a toothed rack axially displaceable in the steering casing, the pinion engaging the rack in an intermeshing fashion;
an electronic control unit; and
an electric motor controlled by the electronic control unit and arranged to act on the rack to supply a power assistance force, the power assistance force applied by the electric motor following, in accordance with a characteristic curve stored in the electronic control unit, a torque that occurs at the steering spindle, the electronic control unit supplied with a first voltage that also supplies an on-board power system of the vehicle, the electric motor supplied with a second voltage generated by a generator that is not connected to the on-board power system, the electric motor arranged as an AC motor connected to a control gear that is controlled by the control unit, the second voltage arranged as an alternating voltage that feeds the electric motor via the control gear.
